(19) United States
(12) Patent Application Publication
(10) Pub. No.: US 2026/0019181 A1
(43) Pub. Date: Jan. 15, 2026

(54) Virtual Frequency Transfer Based on Physical Layer Frequency Measurements

(71) Applicant: Mellanox Technologies, Ltd., Yokneam (IL)

(72) Inventors: Bar Shapira, Tel Aviv (IL); Ariel Almog, Kochav Yair (IL); Natan Manevich, Nesher (IL); Nir Laufer, Zoran (IL); Wojciech Wasko, Mlynek (PL); Dotan David Levi, Kiryat Motzkin (IL)

(21) Appl. No.: 18/772,327

(22) Filed: Jul. 15, 2024

(51) Int. Cl. H04J 3/06

(52) U.S. Cl. CPC H04J 3/0667; H04J 3/0644

(57) ABSTRACT

In one embodiment, a device includes a network interface to send first data at a transmission rate and receive second data at a receive rate, and processing circuitry to send a message to a remote device over a packet data network, the message including data indicative of a measurement of a local clock and a measurement of the receive rate.

### FIELD OF THE DISCLOSURE

The present disclosure relates to computer systems, and in particular, but not exclusively to, clock synchronization.

### BACKGROUND

Clock synchronization among network devices is used in many network applications. One application of using a synchronized clock value is measuring one-way latency from one device to another device. If the clocks are not synchronized the resulting one-way latency measurement will be inaccurate.

A local clock running on a device (e.g., a network interface controller (NIC)) may be synchronized using any suitable method, such as using PTP, SyncE, and/or synchronized to a global navigation satellite system (GNSS).

For Ethernet, there are two complementary methods to achieve synchronization. One is Synchronous Ethernet (SyncE), which is a physical-layer protocol which achieves syntonization based on the receive/transmit symbol rate. SyncE is an International Telecommunication Union Telecommunication (ITU-T) Standardization Sector standard for computer networking that facilitates the transference of clock signals over the Ethernet physical layer. In particular, SyncE enables clock syntonization inside a network with respect to a master clock.

The other is Precision Time Protocol (PTP), which is a packet-based protocol that may be used with SyncE to align offset (e.g., in Coordinated Universal Time (UTC) format) and phase between two clocks. PTP is used to accurately synchronize clocks throughout a computer network, and is considered to be the de facto standard for this purpose. PTP is an example of a two-way time synchronization protocol. A two-way time synchronization protocol uses time synchronization packets which are exchanged in both directions between a clock leader and a clock follower.

### SUMMARY

There is provided in accordance with an embodiment of the present disclosure, a device, including a network interface to send first data at a transmission rate and receive second data at a receive rate, and processing circuitry to send a message to a remote device over a packet data network, the message including data indicative of a measurement of a local clock and a measurement of the receive rate.

Further in accordance with an embodiment of the present disclosure the processing circuitry is to find based on the measurement of the local clock and the measurement of the receive rate, a frequency comparison or a clock adjustment, the message including the frequency comparison or the clock adjustment.

Still further in accordance with an embodiment of the present disclosure, the frequency comparison or the clock adjustment are relative to a first master clock, the processing circuitry being to synchronize the local clock to a second master clock.

Additionally in accordance with an embodiment of the present disclosure the processing circuitry is to find the frequency comparison based on a difference between the measurement of the local clock and the measurement of the receive rate.

Moreover, in accordance with an embodiment of the present disclosure the processing circuitry is to find the measurement of the local clock from the transmission rate.

Further in accordance with an embodiment of the present disclosure the frequency comparison is a ratio between the measurement of the local clock and the measurement of the receive rate.

Still further in accordance with an embodiment of the present disclosure, the device includes at least one counter to count symbols of the first data being sent and the second data being received, wherein the processing circuitry is to find the frequency comparison based on at least one value of the least one counter.

Additionally in accordance with an embodiment of the present disclosure, the device includes a first counter to count symbols of the first data being sent, and a second counter to count symbols of the second data being received, wherein the message includes a value of the first counter and a value of the second counter.

Moreover, in accordance with an embodiment of the present disclosure the processing circuitry is to find a frequency comparison between a clock of a first remote device and a clock of a second remote device based on the measurement of the local clock, and a measurement of a receive rate of data from the first remote device, and a measurement of a receive rate of data from the second remote device, and send the message to the second remote device over the packet data network, the message including the frequency comparison.

Further in accordance with an embodiment of the present disclosure the processing circuitry is to find a first frequency comparison between a clock of a first remote device and the local clock, and a second frequency comparison between a clock of a second remote device and the local clock based on the measurement of the local clock, and a measurement of a receive rate of data from the first remote device, and a measurement of a receive rate of data from the second remote device, and send the message to the second remote device over the packet data network, the message including the first frequency comparison and the second frequency comparison.

Still further in accordance with an embodiment of the present disclosure the processing circuitry is to find a clock adjustment to be made by a second remote device based on a frequency comparison between a clock of a first remote device and a clock of a second remote device based on the measurement of the local clock, and a measurement of a receive rate of data from the first remote device, and a measurement of a receive rate of data from the second remote device, and send the message to the second remote device over the packet data network, the message including the clock adjustment.

There is also provided in accordance with still another embodiment of the present disclosure a method, including sending first data at a transmission rate and receiving second data at a receive rate, and sending a message to a remote device over a packet data network, the message including data indicative of a measurement of a local clock and a measurement of the receive rate.

Additionally in accordance with an embodiment of the present disclosure, the method includes finding based on the measurement of the local clock and the measurement of the receive rate, a frequency comparison or a clock adjustment, the message including the frequency comparison or the clock adjustment.

Moreover, in accordance with an embodiment of the present disclosure the frequency comparison or the clock adjustment are relative to a first master clock, the method further includes synchronizing the local clock to a second master clock.

Further in accordance with an embodiment of the present disclosure the finding includes finding the frequency comparison based on a difference between the measurement of the local clock and the measurement of the receive rate.

Still further in accordance with an embodiment of the present disclosure the finding includes finding the measurement of the local clock from the transmission rate.

Additionally in accordance with an embodiment of the present disclosure the frequency comparison is a ratio between the measurement of the local clock and the measurement of the receive rate.

Moreover, in accordance with an embodiment of the present disclosure, the method includes counting symbols of the first data being sent and the second data being received, wherein the finding includes finding the frequency comparison based on the counting.

Further in accordance with an embodiment of the present disclosure, the method includes counting with a first counter, symbols of the first data being sent, and counting with a second counter, symbols of the second data being received, wherein the message includes a value of the first counter and a value of the second counter.

Still further in accordance with an embodiment of the present disclosure, the method includes find a frequency comparison between a clock of a first remote device and a clock of a second remote device based on the measurement of the local clock, and a measurement of a receive rate of data from the first remote device, and a measurement of a receive rate of data from the second remote device, and wherein the sending includes sending the message to the second remote device over the packet data network, the message including the frequency comparison.

Additionally in accordance with an embodiment of the present disclosure, the method includes finding a first frequency comparison between a clock of a first remote device and the local clock, and a second frequency comparison between a clock of a second remote device and the local clock based on the measurement of the local clock, and a measurement of a receive rate of data from the first remote device, and a measurement of a receive rate of data from the second remote device, and wherein the sending includes sending the message to the second remote device over the packet data network, the message including the first frequency comparison and the second frequency comparison.

Moreover, in accordance with an embodiment of the present disclosure, the method includes finding a clock adjustment to be made by a second remote device based on a frequency comparison between a clock of a first remote device and a clock of a second remote device based on the measurement of the local clock, and a measurement of a receive rate of data from the first remote device, and a measurement of a receive rate of data from the second remote device, and wherein the sending includes sending the message to the second remote device over the packet data network, the message including the clock adjustment.

### BRIEF DESCRIPTION OF THE DRAWINGS

The present disclosure will be understood from the following detailed description, taken in conjunction with the drawings in which:

FIG. 1 is a block diagram view of a clock synchronization system constructed and operative in accordance with an embodiment of the present disclosure;

FIG. 2 is a flowchart including steps in a method of operation of a device in the system of FIG. 1;

FIG. 3 is a block diagram showing a more detailed view of the system of FIG. 1 illustrating a method of clock synchronization;

FIG. 4 is a block diagram view illustrating computation of a frequency comparison for use in the system of FIG. 1;

FIGS. 5-6 are views of example messages for use in the system of FIG. 1;

FIG. 7 is a block diagram view showing a more detailed view of the system of FIG. 1 illustrating finding one or more frequency comparisons between two remote devices or a clock adjustment;

FIG. 8 is a block diagram view illustrating computing two frequency comparison with two remote devices;

FIG. 9 is a block diagram view illustrating computing a single frequency comparison or a clock adjustment based on measurements with respect to two remote devices; and

FIG. 10 is a flowchart including steps in a method of processing a received message in the system of FIG. 1.

### DESCRIPTION OF EXAMPLE EMBODIMENTS

### Overview

As previously mentioned, Synchronous Ethernet (SyncE) is a physical-layer protocol which achieves syntonization based on the receive/transmit symbol rate. A device typically transmits symbols at a symbol rate based on its local clock. If a given device is receiving data from a remote device, the symbol rate of the data received from the remote device is based on the clock frequency of the remote device. Therefore, the given device may compare its symbol receive (RX) rate from the remote device and its symbol transmission (TX) rate to determine a measure of the frequency difference between its local clock and the clock of the remote device. The received symbols and transmitted symbols may be counted (e.g., using separate counters for the RX and TX symbols or a combined counter for both the RX and TX symbols). The counter value(s) may then be used to adjust the local clock to synchronize the clock with the clock of the remote device. The given device will then be transmitting symbols at the same rate as the remote device. Another device receiving data from the given device may synchronize its local clock to the clock of the given device, and so on. In this manner, a master clock frequency may be propagated from one device to another across a network.

In some cases, the above method may not work to transfer a frequency from one device to another across a network. For example, if there are three connected devices, device A, device B and device C, where device A is connected to device B, which is connected to device C, device B may be unable to transfer the clock frequency of device A to device C. This may be due to device B not having the functionality to synchronize (e.g., does not support SyncE) its local clock frequency to the clock of device A (or any device for that matter) and therefore cannot pass the clock of device A to device C. This may also occur if device A and device C are meant to be synchronized to a first clock leader, whereas device B is meant to be synchronized to a second clock leader.

Embodiments of the present disclosure address at least some of the above drawbacks by providing a device which finds a measurement of frequency comparison between its RX symbol rate (which may be found based on a counter counting received symbols) from a first remote device, and its TX symbol rate (which may be found from its local clock or by counting transmitted symbols) and instead of the device adjusting its local clock, the device generates a message including data based on the measurement and sends the message to a second remote device which can then use the data in the message to adjust its local clock to the clock frequency of the first remote device. For example, device B computes a first frequency comparison between the RX symbol rate from device A and the TX symbol rate of device B to give the difference in frequency between the clock of device A and the clock of device B. The first frequency comparison may then be sent to device C. Device C may then compute a second frequency comparison between the RX symbol rate from device B and the TX symbol rate of device C to give the difference in frequency between the clock of device B and device C. The first frequency comparison and the second frequency comparison may then be used to find a third frequency comparison between the clocks of device A and device C. Device C may then adjust its local clock frequency to follow the clock frequency of the clock of device A based on the third frequency comparison. The frequency comparisons may be expressed as a frequency difference or as a ratio of frequencies, as described in disclosed embodiments.

In some embodiments, device B may compute the first frequency comparison and second frequency comparison and send then in one or more messages to device C to compute the third frequency comparison and adjust its local clock frequency to follow the clock frequency of the clock of device A based on the third frequency comparison. In some embodiments, device B may compute the third frequency comparison and send it in a message to device C, and device C adjust its local clock frequency to follow the clock frequency of the clock of device A based on the third frequency comparison.

In some embodiments, device B may compute a clock adjustment (e.g., in parts per million (PPM)) to be used by device C based on the third frequency comparison, or based on any of the data used to compute the third frequency comparison (e.g., RX rates from devices A and C, and TX rate of device B or the local clock of device B). Device B then sends the computed clock adjustment to device C. Device C may then adjust its clock based on the received clock adjustment (e.g., by 5 PPM).

In some embodiments, the different RX and TX rates may be measured using counters which count symbols. Relevant counter values may then be used to compute the first, second, and/or third frequency comparisons. In some embodiments, a single counter may be used by a first device (e.g., device B) to find the difference between the RX and TX rates between that device and a second device (e.g., device A). Therefore, the counter value is representative of the frequency comparison between the clock of the first device and the clock of the second device. In some embodiments, the counter values or difference between the counter values may be inserted in the message sent from one device (e.g., device B) to another device (e.g., device C).

There are various options on how to propagate a clock frequency across a network. For example, device B can compute the first, second and/or third frequency comparison as described above. In other embodiments, device A may compute the first frequency comparison and send a message to device C including the first frequency comparison. Device C may then compute the second frequency comparison and then compute the third frequency comparison from the first and second frequency comparisons.

In other embodiments, device A may compute the first frequency comparison and device B computes the second frequency comparison, and device A sends the first frequency comparison to device C, and device B sends the second frequency comparison to device C. Device C may then compute the third frequency comparison or a clock adjustment based on the first and second frequency comparisons.

When the first and second frequency comparisons originate from different devices (e.g., from device A and B or device A and C or device B and C, etc.) for high accuracy the measurements should be performed at substantially the same time, which either assumes that the measurements are scheduled and the devices are time synchronized, or that a message from one of the devices triggers measurement in the other measuring device.

Embodiments of the present disclosure allow master clocks to be propagated from different master clocks over a topology which is partially common. For example, devices A and C above may be synchronized to a first master clock while device B may be synchronized to a second master clock, and so on.

The above example assumed that the clock frequency of device A may be propagated to device C via device B even though device B does not adjust its local clock to the propagated clock frequency. In a similar manner, if the network includes devices A, B, C, and D and device B and C are not part of the same clock synchronization topology as devices A and D, the clock frequency of device A may be propagated to device D. For example, device B may measure the clock frequency difference between devices A and B and then send this difference to device C. Device C may then compute the difference between the clock frequencies of devices C and B as well as the difference between the clock frequencies of devices C and D. Device C may then compute the difference between the clock frequencies of device A and device D and send this difference or a clock adjustment in a message to device D. The above may be generalized to any N nodes propagating a clock frequency without actually adjusting their clocks to the propagated clock frequency. The above example could be changed so that device B computes the clock frequency differences between devices A and B and between devices B and C and sends this data to device D, which can then compute the difference between the clock frequencies of device A and D based on the received data and the difference between the clock frequencies between device C and device D, and so on.

### System Description

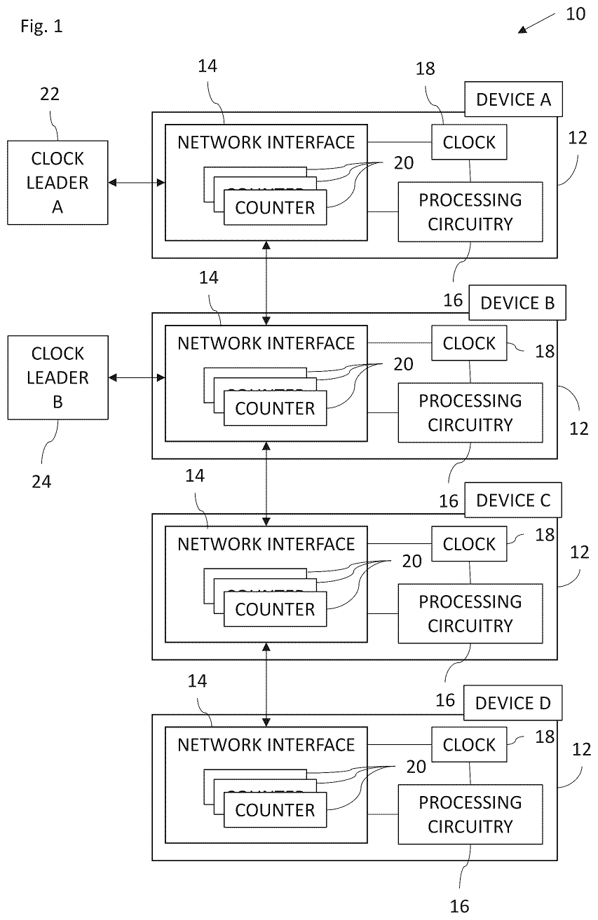

Reference is now made to FIG. 1, which is a block diagram view of a clock synchronization system 10 constructed and operative in accordance with an embodiment of the present disclosure. The clock synchronization system 10 includes devices 12 (e.g., network devices) that are connected to each other via a network (e.g., a packet data network). For the sake of convenience of reference, devices 12 are also labeled as device A, device B, device C, and device D. Each device 12 includes a network interface 14 (e.g., a network interface controller), processing circuitry 16, and a clock 18. The network interface 14 may include one or more counters 20 configured to count symbols of data received and/or data transmitted. Clock 18 may include any suitable elements to generate a local clock signal, such as an oscillator (not shown) and a counter (not shown) or hardware clock to count time. The hardware clock may provide a time-of-day value or may provide a reading which may be processed to provide a time-of-day value using one or more clock parameters. FIG. 1 shows a simple topology with the devices connected back-to-back for the sake of simplicity. Any suitable topology may be used in the present invention.

In the example of FIG. 1, a first master clock is propagated from a clock leader 22 (also labeled “clock leader A”) to device A and then via device B to devices C and D. Device B however does not synchronize its own clock 18 to the first master clock. In the example of FIG. 1, Device B synchronizes its clock 18 to a second master clock propagated from a clock leader 24 (also labeled “clock leader B”). In some embodiments, device B does not synchronize its clock 18 to a remote master clock due to technical deficiencies of device B, for example.

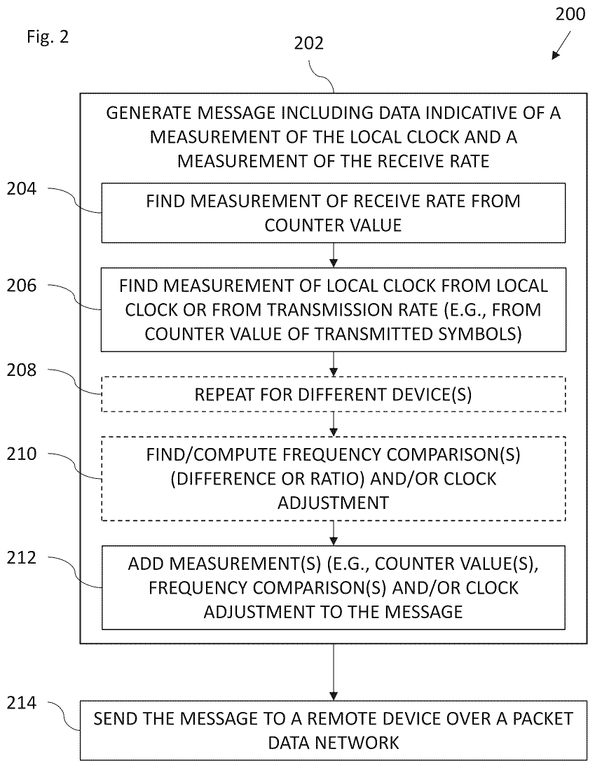

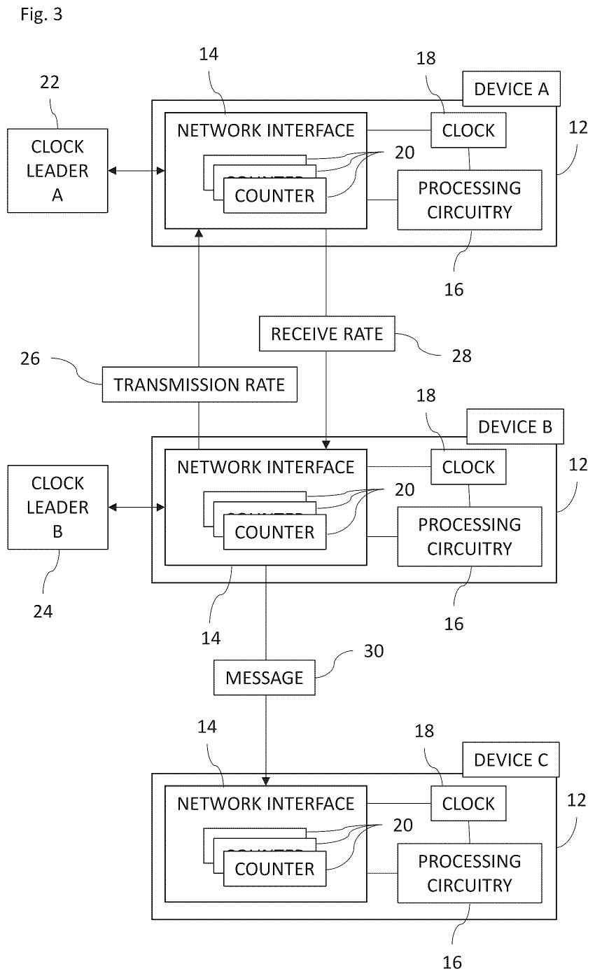

Reference is now made to FIG. 2 and FIG. 3. FIG. 2 is a flowchart 200 including steps in a method of operation of one of the devices 12 (e.g., device B) in system 10 of FIG. 1. FIG. 3 is a block diagram showing a more detailed view of system 10 of FIG. 1 illustrating a method of clock synchronization. The network interface 14 of each device 12 is configured to send data at a transmission rate 26 and receive data at a receive rate 28. The transmission rate 26 of a given device defines the symbol transmission rate from that device and is generally determined by the frequency of the clock 18 of the given device. The data received by the given device from different devices 12 is generally received at different symbol rates and depends on the symbol transmission rates of the different devices 12 and are determined by the respective frequencies of the clocks 18 of the different devices. For example, device B receives data at symbol receive rate 28 from device A, and the receive rate 28 depends on the transmission rate of device A and the frequency of the clock 18 of device A. Device B transmits data at a symbol transmission rate 26 which depends on the frequency of clock 18 of device B. The difference between transmission rate 26 (of device B) and receive rate 28 (of device B from device A) represents the difference between the frequencies of clocks 18 of device A and device B.

The processing circuitry 16 of device B is configured to generate a message 30 including data indicative of a measurement of a local clock (i.e., clock 18 of device B) and a measurement of the receive rate 28 (e.g. of device B from device A) (block 202). The measurement of the local clock may be derived from clock 18 of device B or from transmission rate 26 of symbols by the network interface 14 of device B, e.g., by counting symbols of data being transmitted by the network interface 14 of device B. The measurement of the receive rate 28 may be derived from counting symbols of data received by the network interface 14 of device B from device A, for example.

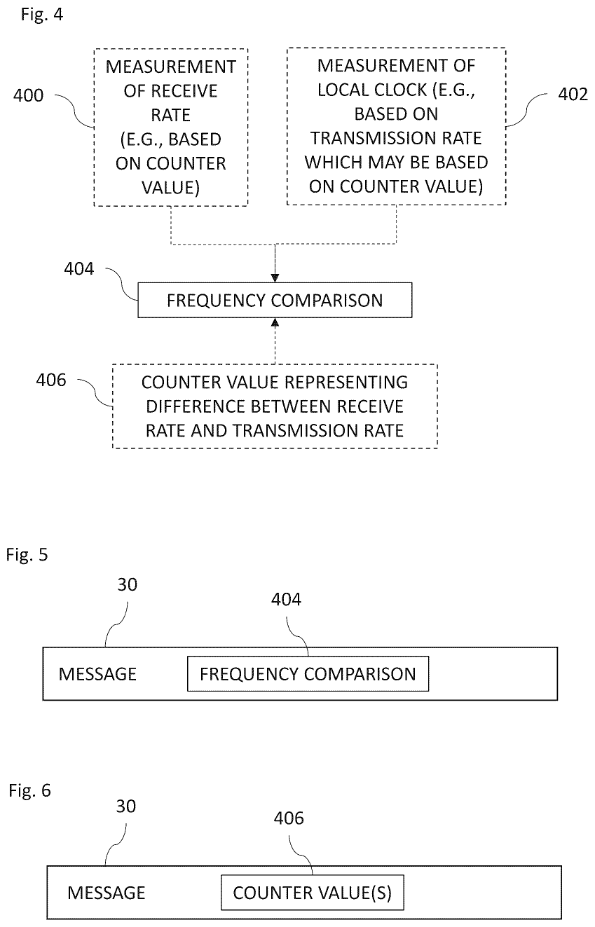

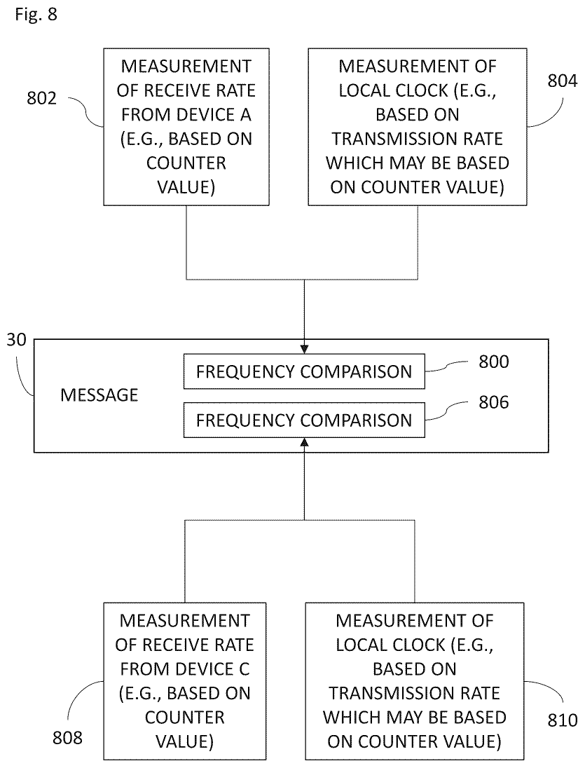

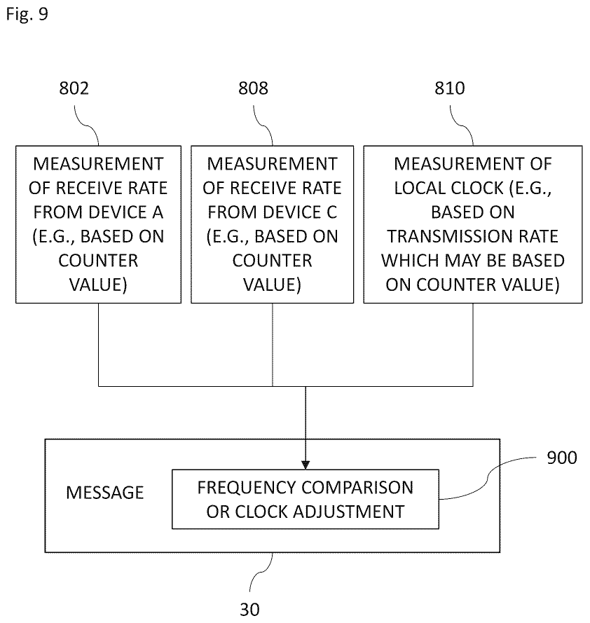

Message 30 includes data to enable a remote device (e.g., device C) to apply a clock adjustment to its local clock 18 (e.g., of device C) based on the data in the message 30 and optionally data included in another message received from another device (e.g., device A) and optionally computations performed by the remote device (e.g., by device C). Message 30 may include a frequency comparison between the frequency of clocks 18 of device A and device B, described in more detail with reference to FIGS. 4 and 5. Message 30 may include a frequency comparison between the frequency of clocks 18 of device A and device C, described in more detail with reference to FIG. 9. Message 30 may include two frequency comparisons, one frequency comparison between the frequency of clocks 18 of device A and device B, and another between the frequency of clocks 18 of device B and device C, described in more detail with reference to FIG. 8. The message may include a clock adjustment to be applied by device C, described in more detail with reference to FIG. 9. Message 30 may include one or more counter values of the counter(s) 20 of device B. The processing circuitry is configured to send message 30 to the remote device (e.g., device C) over the packet data network (block 214).

Reference is now made to FIG. 4, which is a block diagram view illustrating computation of a frequency comparison for use in system 10 of FIG. 1. Reference is also made to FIG. 2. The processing circuitry 16 of device B is configured to find the measurement (block 400) of the receive rate 28 of symbols from device A from a counter value of one of the counters 20 of device B counting the symbols received from device A (block 204). The processing circuitry 16 is configured to find the measurement (block 402) of the local clock from clock 18 of device B or from the transmission rate 26 of sending symbols by device B (block 206). The transmission rate 26 may be found from a counter value of one of the counters 20 of device B counting symbols transmitted by device B. In some embodiments, described in more detail with reference to FIGS. 8 and 9, device B may determine the receive rate 28 from multiple devices 12, e.g., from device A and from device C. Therefore, in some embodiments, the step of block 204 is also repeated with respect to another device or devices (block 208).

The processing circuitry 16 is configured to find based on the measurement of the local clock (e.g., based on the transmission rate 26) of device B and the measurement of the receive rate 28 from device A (and/or C), a frequency comparison (block 404), or a clock adjustment (described with reference to FIG. 9) (block 210). The frequency comparison may provide a comparison between the frequency of clock 18 of device A and clock 18 of device B, as shown in FIGS. 3 and 4. The frequency comparison may additionally or alternatively provide a comparison between the frequency of clock 18 of device B and the clock 18 of device C, as described in more detail with reference to FIG. 8. In some cases, the frequency comparison may provide a comparison between the frequency of clock 18 of device A and device C, as described in more detail with reference to FIG. 9.

In some embodiments, processing circuitry 16 is configured to find the frequency comparison based on a difference between the measurement of the local clock (e.g., based on the transmission rate 26) and the measurement of the receive rate 28. In other embodiments, the frequency comparison is expressed as a ratio between the measurement of the local clock (e.g., based on the transmission rate 26) and the measurement of the receive rate 28.

In some embodiments, the processing circuitry 16 is configured to find the frequency comparison based on the value(s) of the counter(s) 20. For example, if a first counter 20 is counting symbols received by device B from device A, and a second counter 20 is counting symbols transmitted by device B, the processing circuitry 16 may find the frequency comparison based on the different between, or ratio of, the counter value of the first counter and the counter value of the second counter. If a single counter is counting symbols received by device B from device A and symbols sent to device A from device B, i.e., the counter value is incremented for received symbols, and decremented for transmitted symbols (or vice-versa) then the value of the single counter may be used to compute the frequency comparison between clocks 18 of device A and device B (block 406).

In some embodiments, the found frequency comparison or the clock adjustment (found in the step of block 210) are relative to the first master clock of clock leader 22, while the processing circuitry 16 of device B is configured to synchronize the local clock 18 of device B with the second master clock of clock leader 24.

Reference is now made to FIGS. 5-6, which are views of example messages 30 for use in the system 10 of FIG. 1. Reference is also made to FIG. 2.

The processing circuitry 16 is configured to add measurements, and/or frequency comparison(s), and/or a clock adjustment to message 30 (block 212). In the example of FIG. 5, message 30 includes frequency comparison 404. In the example of FIG. 6, message 30 includes one or more counter values 406 which may provide a measurement of the transmission rate 26 and a measurement of the receive rate 28, or a measurement of a frequency difference between the transmission rate 26 and receive rate 28.

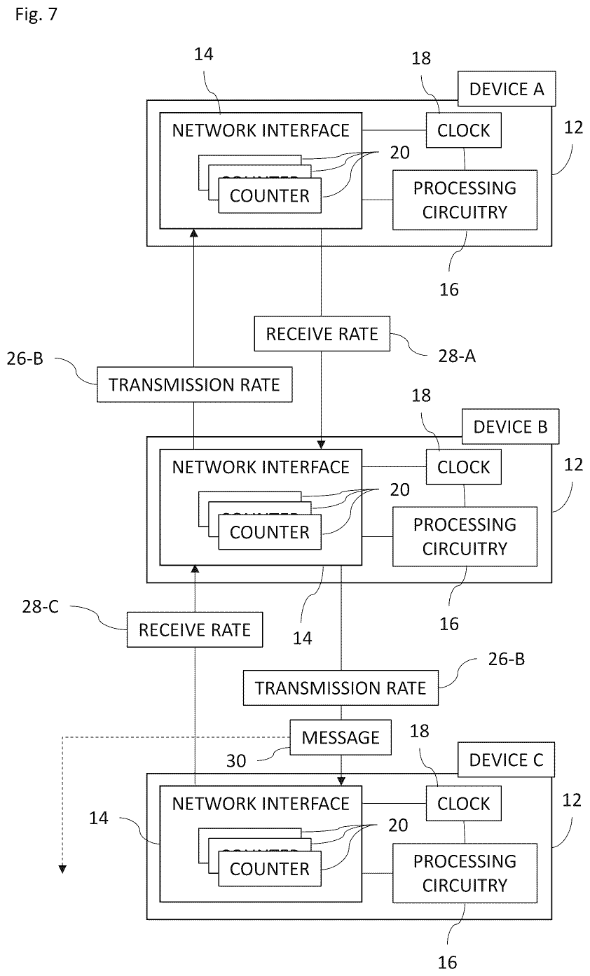

Reference is now made to FIG. 7, which is a block diagram view showing a more detailed view of the system 10 of FIG. 1 illustrating finding one or more frequency comparisons between two remote devices or a clock adjustment. Reference is also made to FIG. 8, which is a block diagram view illustrating computing two frequency comparisons with two remote devices.

FIG. 7 shows that data is transmitted at symbol transmission rate 26-B from device B to both remote devices A and C. Data is received by device B from remote device A with symbol receive rate 28-A and by device B from remote device C with symbol receive rate 28-C. Therefore, processing circuitry 16 of device B may be configured to find a frequency comparison 800 between the clock 18 of a remote device (e.g., device A) and the local clock 18 of device B based on measurements of receive rate 28-A (block 802) and transmission rate 26-B (or the local clock 18 of device B) (block 804). Processing circuitry 16 of device B may also be configured to find a frequency comparison 806 between the local clock 18 of device B and the clock 18 device C based on measurements of receive rate 28-C (block 808) and transmission rate 26-B (or the local clock 18 of device B) (block 810). The processing circuitry 16 of device B is configured to add the frequency comparison 800 and block 802 to message 30 and send the message 30 to another remote device (e.g., device C). The receive rates and/or transmission rates may be found from one or more counter values or one or more counters 20 maintained by device B.

Reference is now made to FIG. 9, which is a block diagram view illustrating computing a single frequency comparison 900 or a clock adjustment based on measurements with respect to two remote devices (e.g., device A and device C).

The processing circuitry 16 of device B may be configured to find the clock adjustment to be applied by device C (based on a frequency comparison between clock 18 of device A and clock 18 of device C) or find the single frequency comparison 900 between the frequency of clocks 18 of device A and device C, based on frequency comparisons 800, 806 of FIG. 8. In some embodiments, processing circuitry 16 of device B may be configured to find the clock adjustment to be applied by device C or find the single frequency comparison 900, based on measurements of: receive rate 28-A (block 802); receive rate 28-C(block 808); and transmission rate 26-B (or the local clock 18 of device B) (block 810). The receive rates and/or transmission rates may be found from one or more counter values of one or more counters 20 maintained by device B. The processing circuitry 16 is configured to add the frequency comparison 900 and/or the clock adjustment to message 30 and send message 30 including frequency comparison 900 and/or the clock adjustment to another remote device (e.g., device C).

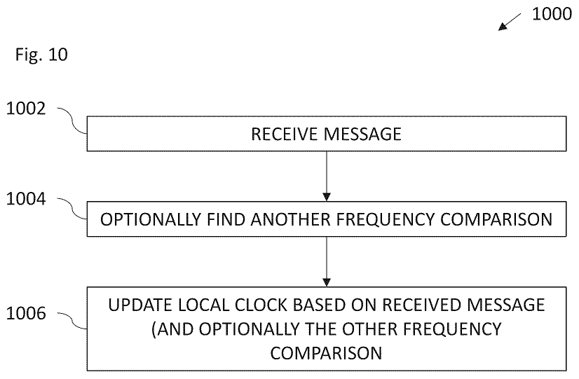

Reference is now made to FIG. 10, which is a flowchart 1000 including steps in a method of processing a received message 30 in system 10 of FIG. 1. The network interface 14 of device C is configured to receive message 30 from device B (block 1002). The processing circuitry 16 of device C is configured to optionally find another frequency comparison (e.g., a frequency comparison between the frequency of the clocks 18 of device B and device C) (block 1004). The processing circuitry 16 of device C is configured to update the clock 18 of device C based on the data in the received message 30 and optionally the frequency comparison found in the step of block 1004 (block 1006).

The frequency correction may be implemented in open-loop or closed-loop. In open loop, the processing circuitry 16 attempts to equalize frequency between two clocks without attempting to equalize the number of symbols in the long term. In closed loop, the processing circuitry 16 also attempts to ensure that clock phase does not drift even though the frequency is being corrected.

In practice, some, or all of the functions of processing circuitry 16 may be combined in a single physical component or, alternatively, implemented using multiple physical components. These physical components may comprise hard-wired or programmable devices, or a combination of the two. In some embodiments, at least some of the functions of processing circuitry 16 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A device, comprising:
a network interface to send first data at a transmission rate and receive second data at a receive rate; and
processing circuitry to send a message to a remote device over a packet data network, the message including data indicative of a measurement of a local clock and a measurement of the receive rate.

2. The device according to claim 1, wherein the processing circuitry is to find based on the measurement of the local clock and the measurement of the receive rate, a frequency comparison or a clock adjustment, the message including the frequency comparison or the clock adjustment.

3. The device according to claim 2, wherein the frequency comparison or the clock adjustment are relative to a first master clock, the processing circuitry being to synchronize the local clock to a second master clock.

4. The device according to claim 2, wherein the processing circuitry is to find the frequency comparison based on a difference between the measurement of the local clock and the measurement of the receive rate.

5. The device according to claim 2, wherein the processing circuitry is to find the measurement of the local clock from the transmission rate.

6. The device according to claim 2, wherein the frequency comparison is a ratio between the measurement of the local clock and the measurement of the receive rate.

7. The device according to claim 2, further comprising at least one counter to count symbols of the first data being sent and the second data being received, wherein the processing circuitry is to find the frequency comparison based on at least one value of the least one counter.

8. The device according to claim 1, further comprising:
a first counter to count symbols of the first data being sent; and
a second counter to count symbols of the second data being received, wherein the message includes a value of the first counter and a value of the second counter.

9. The device according to claim 1, wherein the processing circuitry is to:
find a frequency comparison between a clock of a first remote device and a clock of a second remote device based on the measurement of the local clock, and a measurement of a receive rate of data from the first remote device, and a measurement of a receive rate of data from the second remote device; and
send the message to the second remote device over the packet data network, the message including the frequency comparison.

10. The device according to claim 1, wherein the processing circuitry is to:
find a first frequency comparison between a clock of a first remote device and the local clock, and a second frequency comparison between a clock of a second remote device and the local clock based on the measurement of the local clock, and a measurement of a receive rate of data from the first remote device, and a measurement of a receive rate of data from the second remote device; and
send the message to the second remote device over the packet data network, the message including the first frequency comparison and the second frequency comparison.

11. The device according to claim 1, wherein the processing circuitry is to:
find a clock adjustment to be made by a second remote device based on a frequency comparison between a clock of a first remote device and a clock of a second remote device based on the measurement of the local clock, and a measurement of a receive rate of data from the first remote device, and a measurement of a receive rate of data from the second remote device; and
send the message to the second remote device over the packet data network, the message including the clock adjustment.

12. A method, comprising:
sending first data at a transmission rate and receiving second data at a receive rate; and
sending a message to a remote device over a packet data network, the message including data indicative of a measurement of a local clock and a measurement of the receive rate.

13. The method according to claim 12, further comprising finding based on the measurement of the local clock and the measurement of the receive rate, a frequency comparison or a clock adjustment, the message including the frequency comparison or the clock adjustment.

14. The method according to claim 13, wherein the frequency comparison or the clock adjustment are relative to a first master clock, the method further comprising synchronizing the local clock to a second master clock.

15. The method according to claim 13, wherein the finding includes finding the frequency comparison based on a difference between the measurement of the local clock and the measurement of the receive rate.

16. The method according to claim 13, wherein the finding includes finding the measurement of the local clock from the transmission rate.

17. The method according to claim 13, wherein the frequency comparison is a ratio between the measurement of the local clock and the measurement of the receive rate.

18. The method according to claim 13, further comprising counting symbols of the first data being sent and the second data being received, wherein the finding includes finding the frequency comparison based on the counting.

19. The method according to claim 12, further comprising:
counting with a first counter, symbols of the first data being sent; and
counting with a second counter, symbols of the second data being received, wherein the message includes a value of the first counter and a value of the second counter.

20. The method according to claim 12, further comprising find a frequency comparison between a clock of a first remote device and a clock of a second remote device based on the measurement of the local clock, and a measurement of a receive rate of data from the first remote device, and a measurement of a receive rate of data from the second remote device, and wherein the sending includes sending the message to the second remote device over the packet data network, the message including the frequency comparison.

21. The method according to claim 12, further comprising finding a first frequency comparison between a clock of a first remote device and the local clock, and a second frequency comparison between a clock of a second remote device and the local clock based on the measurement of the local clock, and a measurement of a receive rate of data from the first remote device, and a measurement of a receive rate of data from the second remote device, and wherein the sending includes sending the message to the second remote device over the packet data network, the message including the first frequency comparison and the second frequency comparison.

22. The method according to claim 12, further comprising finding a clock adjustment to be made by a second remote device based on a frequency comparison between a clock of a first remote device and a clock of a second remote device based on the measurement of the local clock, and a measurement of a receive rate of data from the first remote device, and a measurement of a receive rate of data from the second remote device, and wherein the sending includes sending the message to the second remote device over the packet data network, the message including the clock adjustment.
